(19) United States
(12) Patent Application Publication
(10) Pub. No.: US 2025/0027519 A1
(43) Pub. Date: Jan. 23, 2025

(54) QUICK MOUNT SYSTEM FOR BOW AND OTHER ACCESSORIES

(71) Applicant: HAMSKEA ARCHERY SOLUTIONS LLC, Frederick, CO (US)

(72) Inventors: Scott Wilson, Brighton, CO (US); Steve Rysdam, Fort Lupton, CO (US); Walter Jordan, Briggsdale, CO (US); Devin Hall, Ft. Collins, CO (US)

(21) Appl. No.: 18/775,074

(22) Filed: Jul. 17, 2024

Related U.S. Application Data
(60) Provisional application No. 63/514,573, filed on Jul. 20, 2023.

(51) Int. Cl. F16B 5/00; F41B 5/14

(52) U.S. Cl. CPC F16B 5/00; F41B 5/1442

(57) ABSTRACT

A quick mount system is disclosed for removably attaching an bow or accessory to a mounting structure. An example quick mount system includes a first interfacing component having a receiving element formed therein. The example quick mount system also includes a second interfacing component having a coupler assembly configured to mate with the receiving element in a first position. The coupler assembly rotates into an engagement position relative to the first interfacing component. The example quick mount system also includes a magnetic coupler. The magnetic coupler maintains the first interfacing component and the second interfacing component in the engagement position to attach the accessory to the mounting structure.

### PRIORITY CLAIM

This application claims the priority filing benefit of U.S. Provisional Patent Application No. 63/514,573 filed Jul. 20, 2023 for “Quick Mount System For Bow Accessories” of Scott Wilson, et al., hereby incorporated by reference in its entirety as though fully set forth herein.

### BACKGROUND

The vast array of device accessories available today is a result of ongoing technological innovation, consumer demand for customization, and the need for adding functionality after devices have been purchased. Take for example, the archery bow. A modern bow has many accessories that make up the system or kit. Accessories attach to the bow structure on any surface or side of the bow, which can include the handle (or riser), limbs, and cams. Accessories are generally attached to any surface or feature integral (or monolithic) to the bow handle. These features range from a variety of threaded holes, to more complex geometries that may include vertical or horizontal dovetail shapes. Archers use a variety of arrow configurations to optimize the arrows' speed, diameter and stability for a particular discipline of archery (e.g., hunting, target, etc.). As a result, the accessories that provide stability, sighting references, arrow support and arrow storage need to be tailored for each arrow configuration.

Accessories are not limited to just the aforementioned. Accessories for bows can also include, but are not limited to, real-time kinematic training aids, active data measurement devices, lights, wind indicators, cameras, cell phones, laser range finders and chronographs.

Accessories are also commonplace in other fields of endeavor (cameras and video equipment, hiking, camping and other outdoor equipment, etc.). The list of accessories and their application is endless, but the need remains for a quick and repeatable locking mechanism from which any accessory can be attached or detached or interchanges.

### BRIEF DESCRIPTION OF THE DRAWINGS

FIG. 1 shows a bow system with accessories.

FIG. 2 shows a conventional weight accessory for a bow.

FIG. 3 shows an example quick mount system.

FIG. 4 shows example male and female components of the example quick mount system.

FIG. 5 shows coupling and rotational ramp engagement of the example quick mount system.

FIG. 6 shows intermediate components with magnetic coupling and secondary locking of the example quick mount system.

FIG. 7 shows rotational magnetic coupling shear force of the example quick mount system.

FIG. 8 shows dipole axes for single and multipole magnets of the example quick mount system.

FIG. 9 shows a poly magnet keying and mounting of the example quick mount system.

FIG. 10 shows ball and detent perspective views of the example quick mount system.

FIG. 11 shows rotational disc perspectives of the example quick mount system.

FIG. 12 shows rotational disc alignment perspectives of the example quick mount system.

FIG. 13 shows a secondary locking mechanism and an engager arm of the example quick mount system.

FIG. 14 shows an increased torque feature of the example quick mount system.

FIG. 15 shows a mounting mechanism with integral accessory & mountable to structure of example quick mount system.

FIG. 16 shows serially configured intermediate components of the example quick mount system.

FIG. 17 shows an integral accessory mount of the example quick mount system.

FIG. 18 shows accessory mounting perspectives of the example quick mount system.

FIG. 19 shows rotational mounting perspectives of the example quick mount system.

FIG. 20 shows a mounting mechanism female component integral to a structure of the example quick mount system.

FIG. 21 shows a mounting mechanism male component integral to a structure of the example quick mount system.

### DETAILED DESCRIPTION

A need exists for a quick and repeatable mounting mechanism that enables an user to switch between device configurations and various accessories. Example accessories for bow systems include, but are not limited to, sights, scopes, pins, arrow rests, stabilizer, stabilizer weights and dampeners, quivers. Other accessories for bow systems and other devices are too numerous to name, but can also benefit from the quick mount system disclosed herein.

A quick mount system with quick locking and detachment mechanism is disclosed herein, as it may be provided for attaching and detaching bow and other accessories to a mounting structure. An example of the quick mount system includes a first interfacing component having a receiving element formed therein. The example quick mount system also includes a second interfacing component having a coupler assembly configured to mate with the receiving element in a first position. The coupler assembly rotates into an engagement position relative to the first interfacing component. A magnetic coupler maintains the first interfacing component and the second interfacing component in the engagement position to attach the accessory to the mounting structure.

In an example, the quick mount system also includes an interference interface between the first interfacing component and the second interfacing component. The interference interface limits rotation of the first interfacing component and the second interfacing component relative to each other. The interference interface may include at least one ramp formed on the receiving element formed in the first interfacing component, and at least one corresponding ramp on the coupler assembly of the second interfacing component.

In an example, the relative rotational position between two components of the mechanism is angularly located and fixed by complementary ramp features. This rotational locking mechanism locates the two components relative to each other in the vertical and horizontal axes simultaneously. An additional coupling force secures the two components together (e.g., through compression or magnetically). To decouple the components, an external torque is applied to one component relative to the other.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. The device is not limited to any particular end-use or category of devices. While described herein primarily as it may be implemented with bow systems for archery, it is understood that the quick mount system may be implemented with any of a wide variety of different accessories in any field of endeavor not limited to archery or bow systems. Other devices and/or device configurations may be utilized to carry out the operations described herein.

The operations shown and described herein are provided to illustrate example implementations. It is noted that the operations are not limited to the ordering shown. Still other operations may also be implemented.

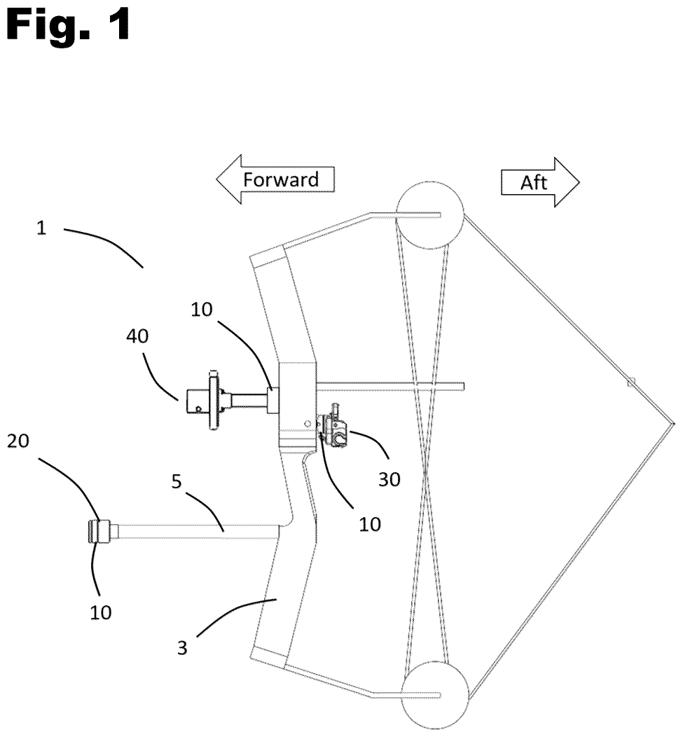

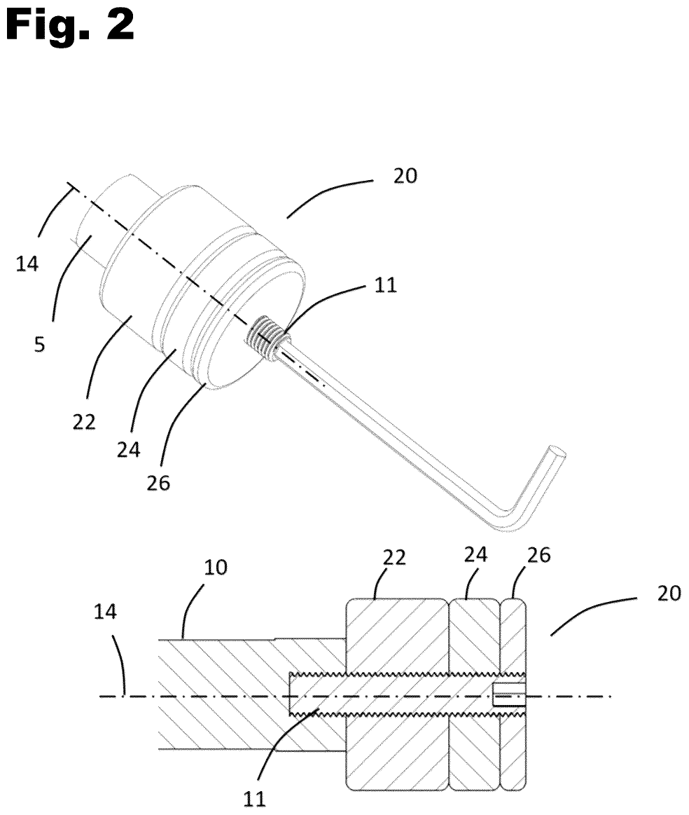

FIG. 1 shows a bow system with accessories. FIG. 2 shows a conventional weight accessory for a bow. In a bow system 1, accessories such as a weight 20, arrow rest 30, sight 40 and quivers (not shown) are mounted to the bow structure 3, or through an intermediate structure 5 connected to the bow structure 3. In the case of weights 20, individual weights 22, 24, and 26 are threaded onto a threaded rod 11 serially about the axis of rotation 14. To make incremental changes requires unthreading and threading the weight onto the rod 11. In the case of accessories 30 and 40, oftentimes the accessory is mounted directly to the bow structure 3 making it difficult to quickly change the accessory to adjust to changes in shooting conditions.

A quick mount system is disclosed herein as it may be implemented to attach and detach bow and other accessories, such as a weight 20, arrow rest 30 or sight 40 to a structure 3 or through an intermediate structure 5 connected to the mounting structure 3. Examples of other bow accessories can include, but are not limited to, lights, cameras, containers and quivers (not shown). The quick mount system 100 may also be implemented for other types of accessories and is not limited to the field of archery.

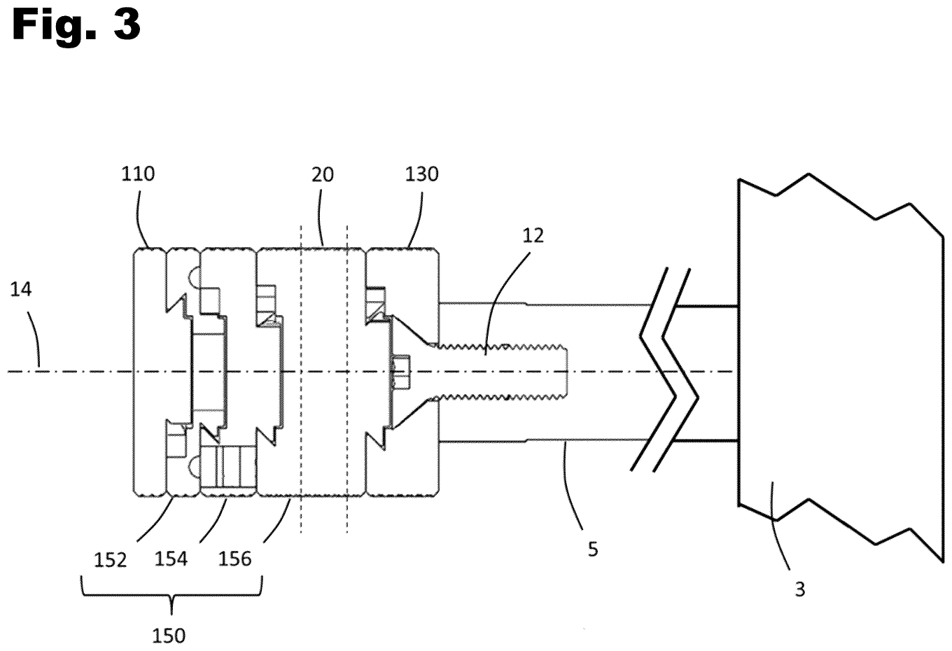

FIG. 3 shows an example quick mount system 100 for securing an accessory (e.g., weight 120) to a structure 3, in this example via an intermediate structure 5. In an example, the quick mount system 100 includes at least one male component 110 and at least one female component 130. The female component may be attached to the intermediate structure 5 via screw 112 or other attachment. Additional intermediate components 150 (e.g., additional weight structures 152, 154 and 156) may be provided between the male component 110 and the female component 130. The mounting axis 14 is defined as the axis of rotation between the male 110 and female 130 components. The mounting mechanism serves as an intermediate interface between the mounting structure 3 or 5 and the accessory (e.g., accessory 20, 30 or 40 in FIG. 1).

A quick mount system for removably attaching an accessory to a mounting structure is disclosed, including a first interfacing component having a receiving element formed therein. A second interfacing component having a coupler assembly is configured to mate with the receiving element in a first position, and rotate into an engagement position relative to the first interfacing component. A magnetic coupler maintains the first interfacing component and the second interfacing component in the engagement position to attach the accessory to the mounting structure.

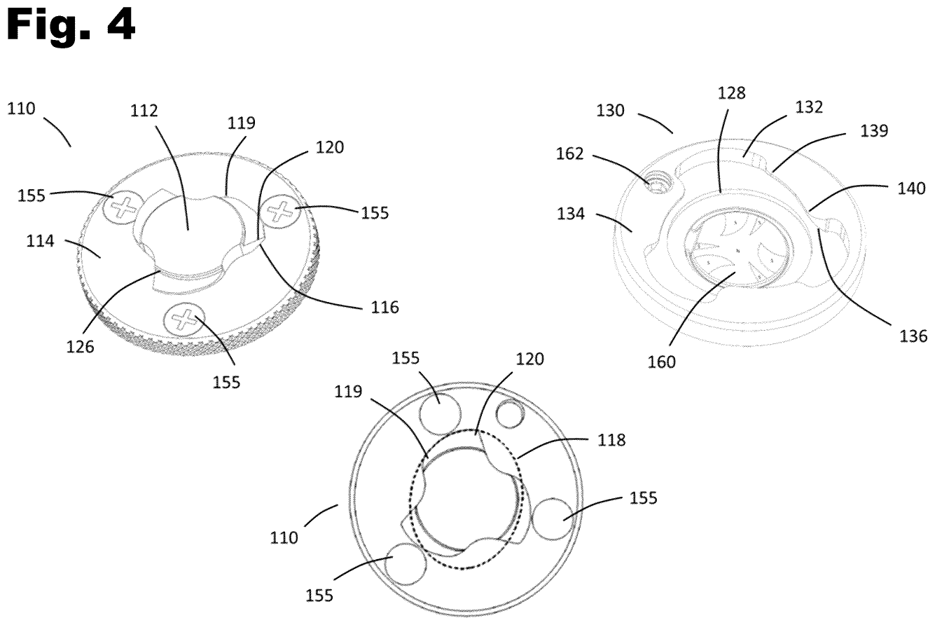

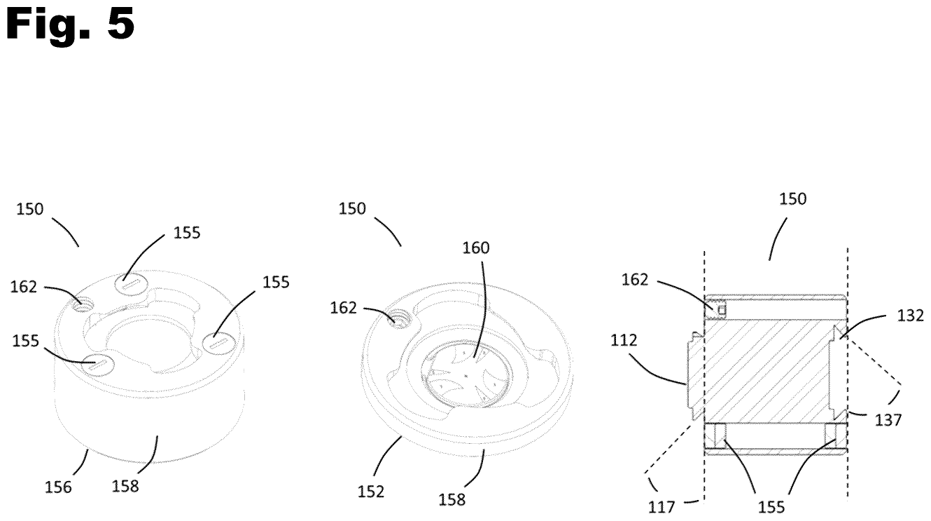

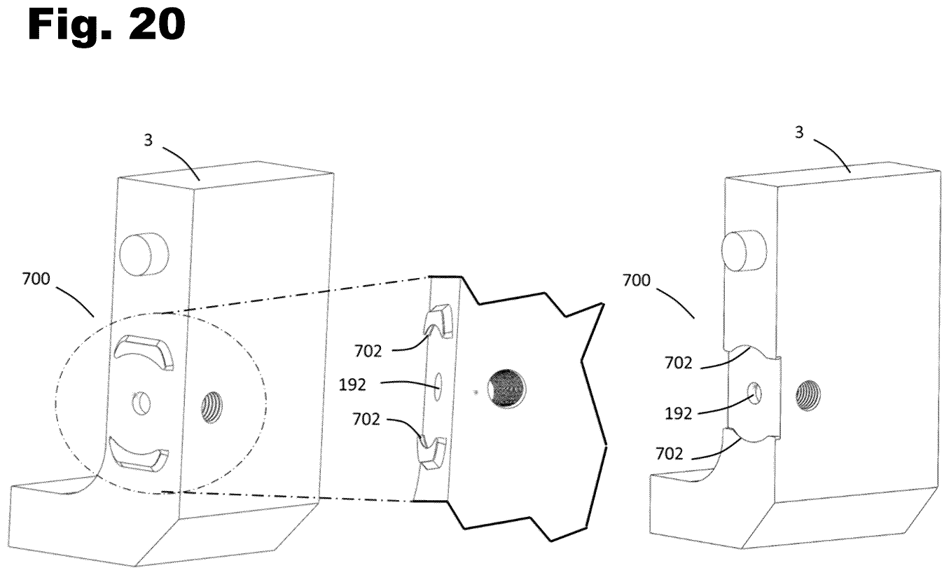

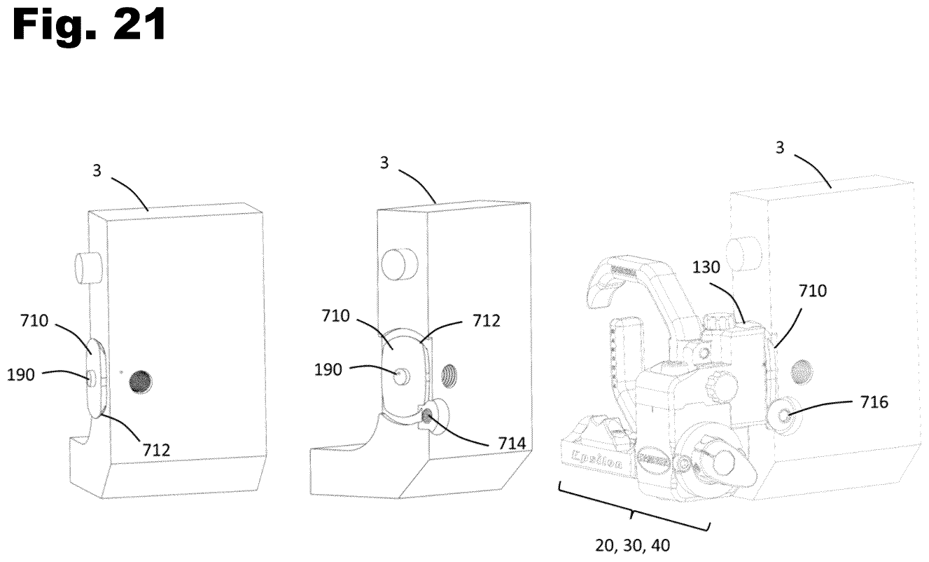

FIG. 4 shows example male and female components of the example quick mount system 100. FIG. 5 shows coupling and rotational ramp engagement of an example quick mount system. In this example, the quick mount system 100 includes a male component 110 with a protrusion 112 extending from a planar surface 114, and a female component 130 with a cavity 132 extending therein from a mating surface 134. Either component 110 or 130 can be mounted to the structure 3 with a minimum of one fastener (e.g., screw 112 in FIG. 3) or made to be integral (e.g., FIGS. 20 and 21) to a mounting structure and/or accessory. The two components 110 and 130 are mated and aligned axially, and are rotated either clockwise or counter clockwise relative to each other.

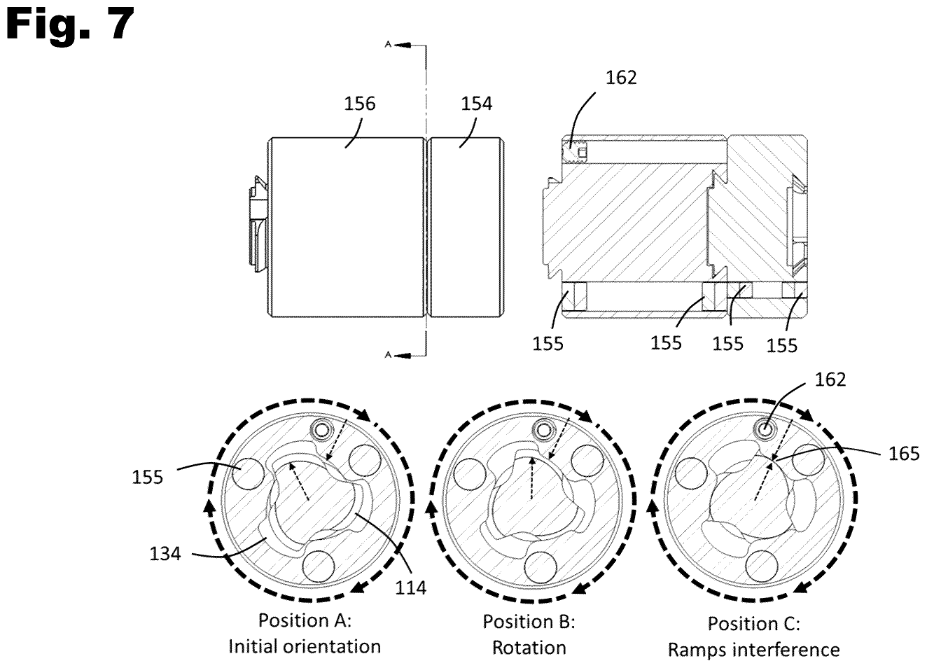

The two components 110 and 130 are connected by inserting the protrusion 112 into the cavity 132, and are rotated along the mounting axis 14 relative to one another. An example protrusion 112 of the male component 110 has at least one circular geometric ramp 116 that, when rotated (or twisted) about the mating axis 14, forces the complementary ramp 136 of the cavity 132 of the female component 130 to interfere (see reference 165 in FIG. 7) with each other, limiting the rotation to less than one relative revolution. The circular shape of the protrusion 112 and cavity 132 co-axially align the components 110 and 130 to one another, mostly parallel to the mating axis 14.

In an example, an interference interface between the first interfacing component and the second interfacing component limits rotation of the first interfacing component and the second interfacing component relative to each other. The interference interface can include at least one ramp formed on the receiving element formed in the first interfacing component. At least one corresponding ramp can be provided on the coupler assembly of the second interfacing component.

In an example, the ramp formed on the receiving element mates with the corresponding ramp on the coupler assembly, and tightens together as the first interfacing component is rotated in a first direction relative to the second interfacing component. The ramp formed on the receiving element mates with the at least one corresponding ramp on the coupler assembly, and loosens from one another as the first interfacing component is rotated in a second direction opposite the first direction relative to the second interfacing component.

In an example, the ramp formed on the receiving element can have a circular shape such that relative rotation between the first interfacing component and the second interfacing component axially align while limiting the rotation to less than one relative revolution.

In an example, the corresponding ramp formed on the coupler assembly has an elliptical shape such that relative rotation between the first interfacing component and the second interfacing component taxially align while limiting the rotation to less than one relative revolution.

In an example, the circular shape of the receiving element has a diameter that is less than the diameter of the ellipse shape of the coupler assembly.

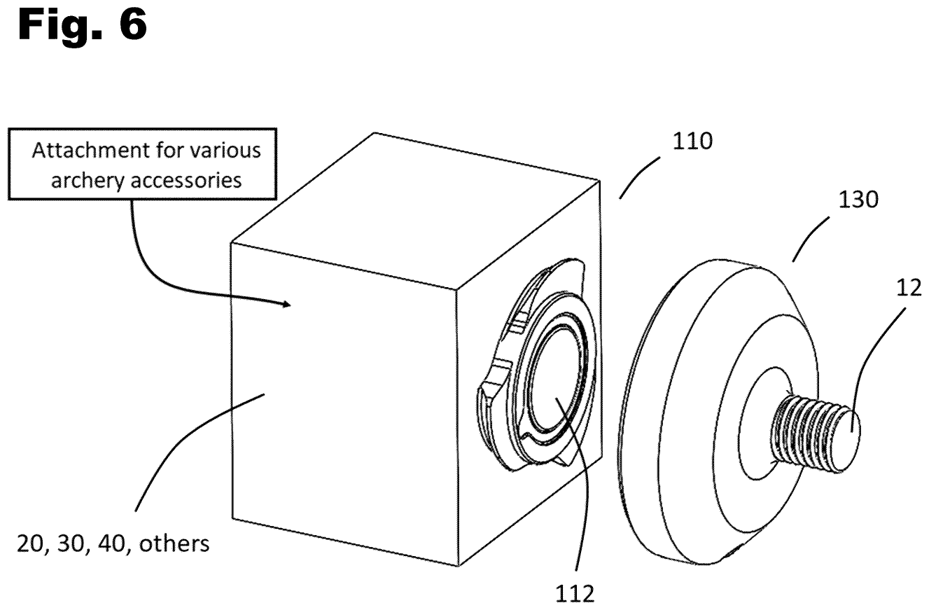

An example protrusion 110 has an oblong elliptical shaped ramp feature 116 with an angle (see reference 117 in FIG. 6) that is less than about 90 degrees. The circular faces of the ramps each have an elliptical shape (e.g., elliptical shape 118 illustrated for ramp 116) with an aspect ratio not equal to one. The first end of ramp 119 has a different distance from the center of rotation compared to the second end of ramp 121. The female ramp 136 has an elliptical shape mostly matching 118, with an angle 137 that is less than about 90 degrees and generally matches the angle of the protrusion 117 (FIG. 6) with an aspect ratio not equal to one.

In an example, the first end 139 of the ramp has a different distance from the center of rotation compared to the second end 140 of the ramp, and matches the male ramp geometry. The female ramp 136 outer diameter is slightly larger than the male ramp 116 to allow for engagement prior to rotation. In an example, a plurality or multiple (more than one) complementary mating ramps 116 and 136 may be provided.

The protrusion 112 and cavity 132 may also be implemented in any intermediate component 150, allowing the accessory to be positioned further away from the mounting structures 3 and 5. These intermediate components 152, 154 and 156 work together as a system with varying axial dimensions (see components 158a, 158b in FIG. 5), when configured as a single intermediate component or combinations with one another, to set unique dimensional offsets of the accessories (e.g., accessories 20, 30 and 40 relative to the mounting structures 3 and 5 in FIG. 1). In an example, the protrusion 112 and cavity 132 are integral (monolithic) to an accessory. In another example, these may be separate components mounted to the accessory (e.g., accessory 20, 30 and/or 40 in FIG. 1).

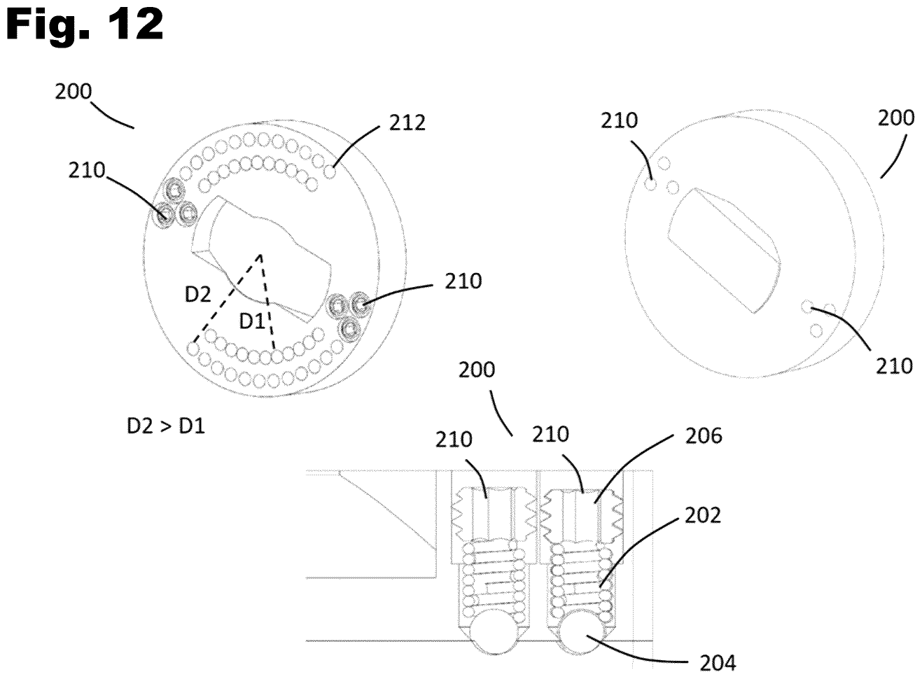

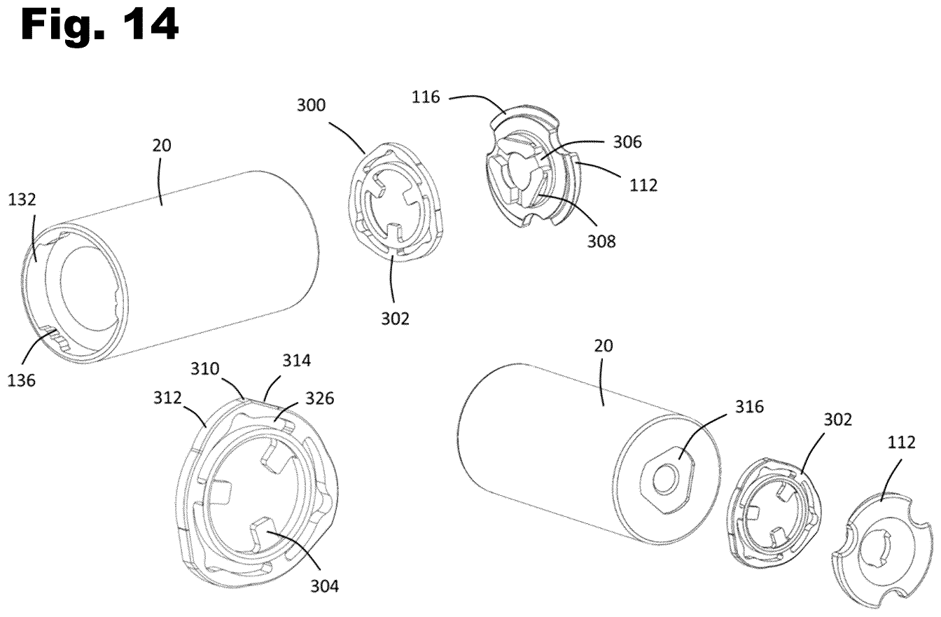

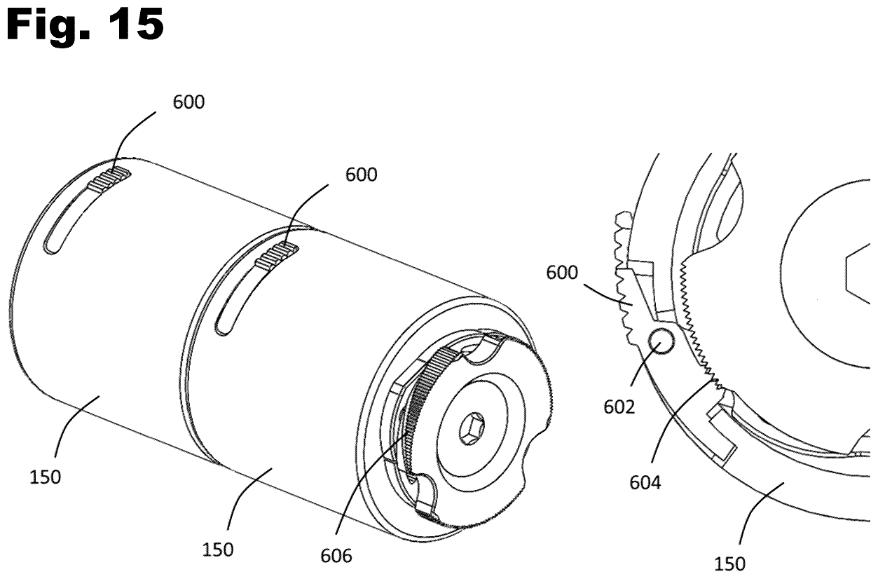

To maintain the two components 110 and 130 in a mated rotational orientation, an external locking force is applied relative to the two components that increases the coupling force between the two components. To overcome this locking force, a greater unlocking force/torque is required to overcome the locking force. The locking force can be generated with a secondary locking mechanism, such as, but not limited to, set screws (e.g., provided in opening 162 in FIG. 5), magnets (e.g., references 155 or 160 in FIG. 5), detents (e.g., references 212 and 210 in FIG. 12), compliant cam lock (e.g., reference 300 in FIG. 14), or lock-ratchet (e.g., reference 600 in FIG. 15). Secondary locking forces may be necessary depending on the application and the size, weight and mass of the accessory.

FIG. 6 shows intermediate components with magnetic coupling and secondary locking of the example quick mount system. In an example, the magnetic coupler generates a magnetic force between at least one magnet on the first interfacing component and at least one corresponding magnet on the second interfacing component. The at least one magnet and the at least one corresponding magnet can be substantially axially aligned in the engagement position. The magnetic fields of the at least one magnet and the at least one corresponding magnet can be substantially parallel to an axis of rotation of the first interfacing component relative to the second interfacing component. The magnetic fields of the at least one magnet and the at least one corresponding magnet can be arranged North-to-South and South-to-North for magnetic coupling. The magnetic field strength of the magnets 155 of the male component 110 and the female component 130 can vary to change the coupling force between the components.

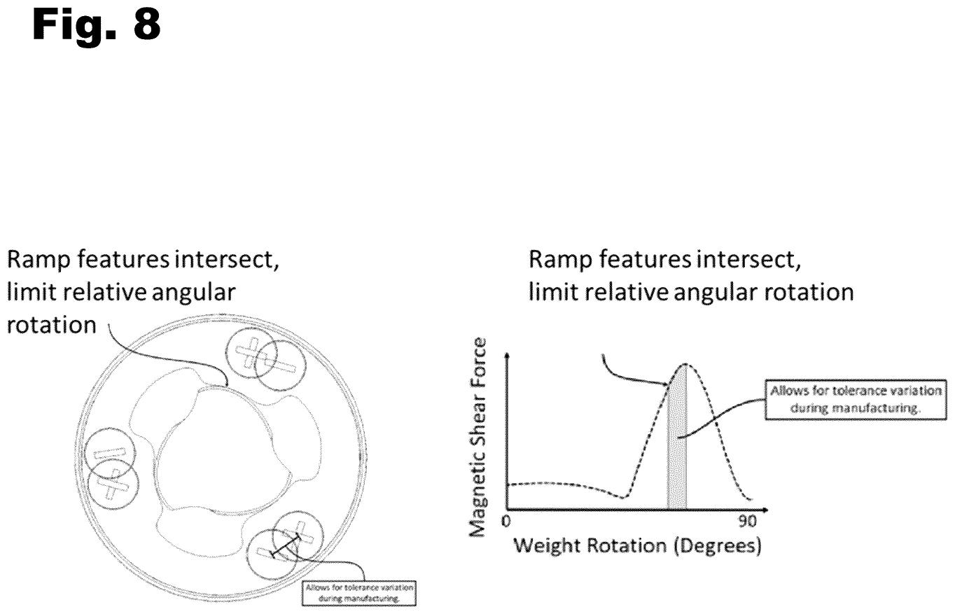

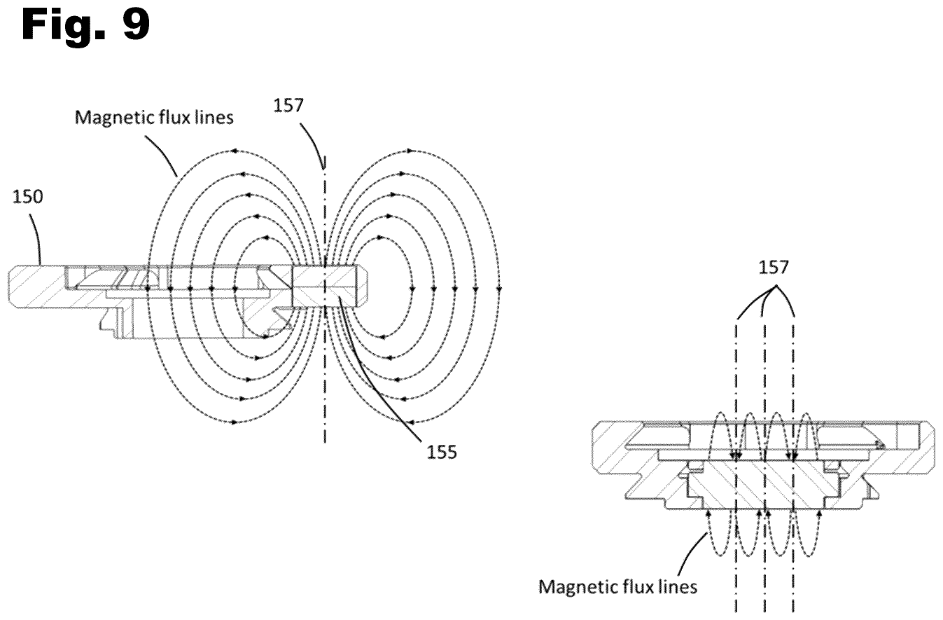

FIG. 7 shows rotational magnetic coupling shear force of an example quick mount system. FIG. 8 shows dipole axes for single and multipole magnets of an example quick mount system. FIG. 9 shows a poly magnet keying and mounting of the example quick mount system.

In an example the dipole magnets 155 are placed on each component 110 and 130 in the same angular orientation. When the ramps intersect during rotation, the magnet dipoles attracting force holds the two components 110 and 130 in place rotationally.

The magnets 155 may be located on a diameter greater than the protrusion ramp 114 diameter, but less than the outer diameter of the locking mechanism on both components 110 and 130. The further away the magnets 155 are from the center of rotation 14, the larger the coupling force becomes, thereby increasing the torque required to decouple the two components 110 and 130 from one another.

An example includes a magnetic force produced by two or more dipole magnets 155, or by one or more multi-pole magnets 160. In any event, there is at least one magnet on each component 110 and 130. When the two components 110 and 130 have been rotated and the mating ramp surfaces 116 and 136 intersect, the magnet dipole magnetic fields moment axes 157 are rotationally aligned such that the axis of each magnet's magnetic field are mostly co-axially aligned with one another. This results in a rotational holding force that requires an external shear force to be applied to overcome the co-aligned magnets 155 or 160.

The magnetic poles of each magnet in each component are configured to magnetically attract (North-to-South, South-to-North), resulting in a force that holds the two components 110 and 130 relative to one another when at their physical limit of rotation by the ramp features 116 and 136. As the components 110 and 130 are rotated, the mating ramp surfaces 116 and 136 intersect, and an attractive or repulsive magnetic force is applied to hold the dovetail features together. These magnets can be affixed to the components with the use of, but not limited to, mechanical press fits, adhesives, retaining rings, splines or fasteners.

When multipole magnets 160 are implemented, these can be mounted centrally along the axis of rotation 14. There are several configurations for mounting the poly magnet in the receiving cavity of the components 110, 130 or 150. In an example, an asymmetric feature of a flat 240 receives a radial fastener to impart a holding force to push the magnet 160 into the side of the cavity. A partial circular feature 242 is provided in conjunction with a pin 244 that locates the magnet in the cavity as the cavity has a matching partial circular feature to 242. Another example includes a snap ring 226 that provides a physical limit to retain the magnet in the cavity. An additional example includes multiple forced detents 228 that are generated by deforming the edge of the cavity, such that a portion of the cavity material yields to forcibly hold the magnet in position. Any of these techniques serve to rotationally orient the magnet dipole axes with the asymmetric feature to align with lock position 165.

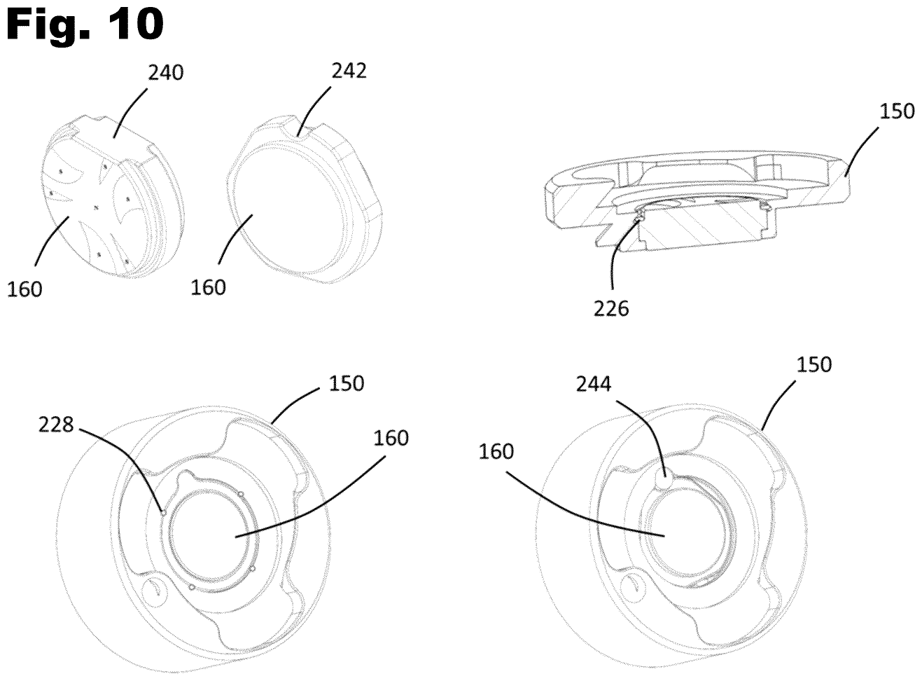

In another example, generating an axial holding force is with a ball spring detent mechanism 200. FIG. 10 shows ball and detent perspective views of the example quick mount system 100 The spring 202 and ball 204 are axially positioned parallel to the axis of rotation, and held in place by a fastener 206. Each spring detent mechanism 210 is spaced at different radial distances D1 and D2 from the center or rotation. The spring loaded balls interfere with a complementary detent feature on the opposite component's complementary detents 212. Once the components are rotated where the ramps mate, the ball(s) 204 and complementary detent 212 are aligned, and the ball is forced into the detent by spring 202. To overcome the position of ball 204 in the detent 212, an external rotational torque is applied to one of the components relative to the other which overcomes the spring's holding force of the ball in the detent. At least one ball detent may be provided in the mounting mechanism.

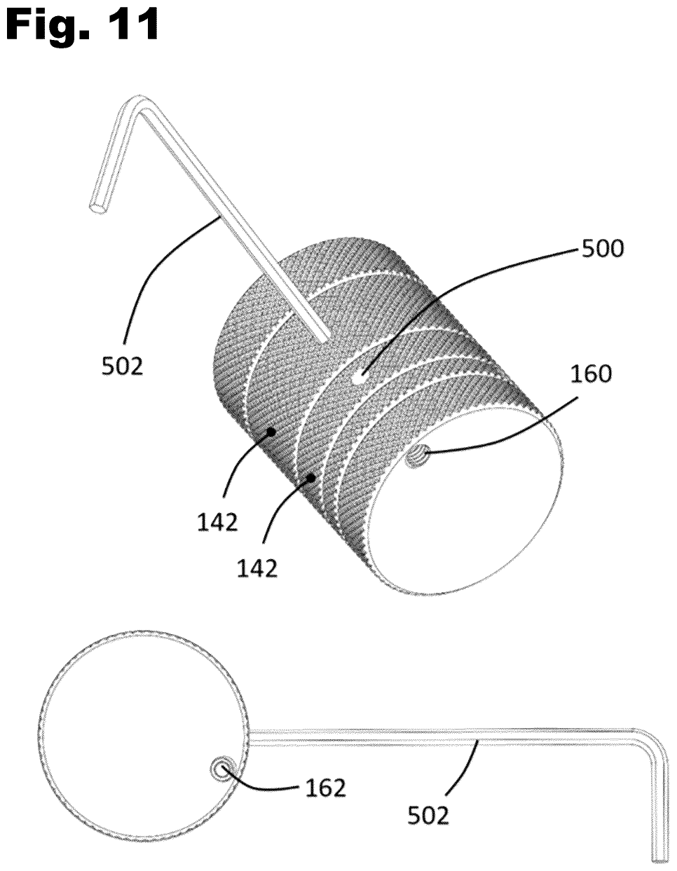

In another example of increased rotational coupling force, the force is imparted through a compliant disc 300 rotationally located at the base of the male component 110. FIG. 11 shows rotational disc alignment perspectives of the example quick mount system 100. FIG. 12 shows rotational disc perspectives of the example quick mount system 100. The disc 302 has an alignment feature 304 that mates with a complementary feature 306 in the male component 110, which orients a minimum of one protrusion 310 that has a leading ramped edge 312 and a trailing ramped edge 314.

In an example, a disc 302 is located between the base of protrusion 110 and the accessory 20. The protrusion 110 and disc 302 are attached to accessory 20 via a fastener 318. The accessory may have a complementary shaped cavity 316 to receive and angularly locate the disc 302 and ramped protrusion 110. The protrusion 110 has a minimum of one circular ramp 320, where the angle is less than 90 degrees. The female component 130 has a cavity 132 and a minimum of one radial protrusion 322 with an integral circular ramp 324, where the angle is less than 90 degrees and complementary to ramp 320.

When protrusion 110 and female component 130 are mated and rotated relative to one another, protrusion 322 rotates and intersects the leading edge of disc 302. This serves as a cam/lobe that, when rotated relative to the male component 110, the lobe intersects the protrusion ramp 312. As the rotation continues, protrusion 322 yields the disc by applying a radial force to the disc protrusion 310. The void 326 in disc 302 enables the protrusion 310 to yield, and allows the component protrusion 322 to continue to rotate to intersect with the trailing ramp 314 of the disc 302.

In an example, the angular rotation is limited by ramps 320 and 324 intersecting. This point of limited rotation 330 angularly locates protrusion 322 on the trailing ramp 314. By doing so, the yielded protrusion 310 is relaxed back to its natural circular shape, resulting in an outward radial force. As the force is applied to the trailing ramp 314, a tangential rotational force is applied to the protrusion, resulting in a continuous locking force. This locking force keeps the complementary ramps 320 and 324 constantly engaged.

To overcome this holding force, a torque is applied by twisting one component relative to the other, which rotates protrusion 322 up the protrusion trailing ramp 314, recompressing the disc protrusion 310, and the cam 322 ultimately is relieved of the bias force generated by the disc 302 relaxing back to its natural circular shape.

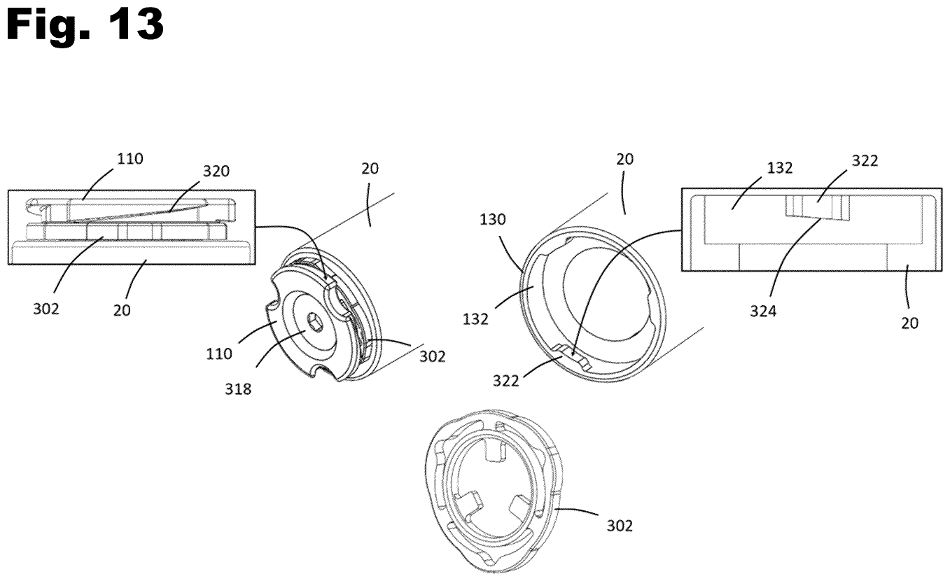

FIG. 13 shows a secondary locking mechanism and an engager arm of the example quick mount system 100. In this example, the secondary locking mechanism includes a spring loaded arm 600 that pivots about a pin 602. One end of the arm 600 has engagers 604 complementary to the engagers 606 on the protrusion 112. To decouple the intermediate components 150 from one another, the lever arm is pressed to overcome the spring (not shown) to decouple the engagers 604 and 606 from one another, allowing the components to be rotated apart.

In this example, the locking arm 600 is mounted on a pin 602 on either of the first or second interfacing components to pivot about the pin 602 between an unlocked position and a locked position. The secondary locking mechanism also includes a spring for biasing the locking arm in the locked position. The arm is manually operable to pivot about the pin against a biasing force of the spring to release the arm from the locked position. There is at least one tooth (and a plurality of teeth are shown) or engagement mechanism on the arm to ratchet-engage with a plurality of teeth on the coupler assembly. The arm 600 automatically pivots into the unlocked position as the first and second interfacing components rotate relative to one another into the engagement position. The arm 600 automatically pivots into the locked position after the first and second interfacing components are in the engagement position.

The secondary forces are generated by further increasing the coupling force between components 110 and 130, e.g., by a fastener, or by other means such as, but not limited to, a cam locking system (not shown).

In the case of a more permanent locking mechanism, a set screw featuring external threads is mated in a drilled and tapped hole featuring internal threads. As this set screw assembly is tightened, the mating ramps 116 and 136 features are forced together rigidly. With this option, the user can choose to mate the two components of the locking mechanism together temporarily or permanently.

A centering feature 126 on the male component protrusion 112 includes an extruded cylindrical shape that mates with the tangent edges of the female cavity 132, receiving cylindrical shape 128. This allows for easier rotation of the two components.

FIG. 14 shows an increased torque feature of the example quick mount system 100. In this example, the outer surface of the components incorporates a high friction material/coating/surface modification 142 to allow for easy user grip of the components when rotating them relative to one another in all conditions.

To increase torque, a radial hole 500 is located on the outer surface of each component. A long cylindrical tool such as, but not limited to, an Allen wrench 502 can be inserted into the hole to increase the moment arm that the shear force is applied. This allows for more leverage to be applied to the system in the case of components being difficult to separate.

FIG. 15 shows a mounting mechanism with integral accessory and mountable to structure of example quick mount system 100. In an example, accessories (e.g., accessories 20, 30 and 40 in FIG. 1) may have secondary mounting structures. These may be of a Picatinny or other geometric shape that can be mounted (e.g., via fasteners, adhesives or other slidably coupled features) to either component of the mechanism. In another example, the secondary mounting structure can be integral (e.g., monolithic or one piece) to one or both of the components 110 and/or 130. The components 110 and/or 130 can be mounted to any part or component of a bow structure 3 or 5 to orient the accessories (e.g., accessories 20, 30 or 40) in any configuration to optimize the archery system.

Arrow rests 30 and sights 40 accessories are generally mounted on the outward facing side of a bow handle 3, but have also been mounted to the forward and aft facing surfaces of a bow handle 3. In the case of an arrow rest 30, the need to quickly exchange one arrow rest optimized for a small diameter arrow for outdoor archery with a different arrow rest optimized for a larger diameter arrow for indoor or 3D archery, allows the archer to use one bow system 1 for several different archery applications. In an example, the male component 110 of the quick mount system 100 can be mounted to the aft facing surface of a bow handle 3, and the female component 130 of the locking mechanism incorporates the arrow rest mount adapter 164 (e.g., vertical Picatinny rail). In this example, the arrow rest mount 164 is integral (monolithic or one-piece) to the female component 130. The arrow rest mount 164 can be a separate element that is coupled to the female or male component 130 and 110 with, but not limited to, fasteners, adhesives, etc.

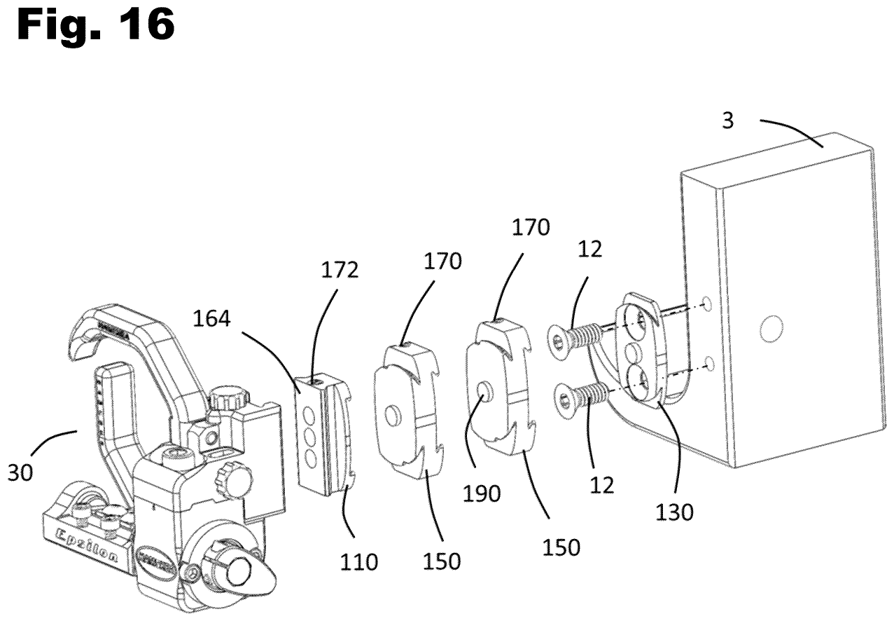

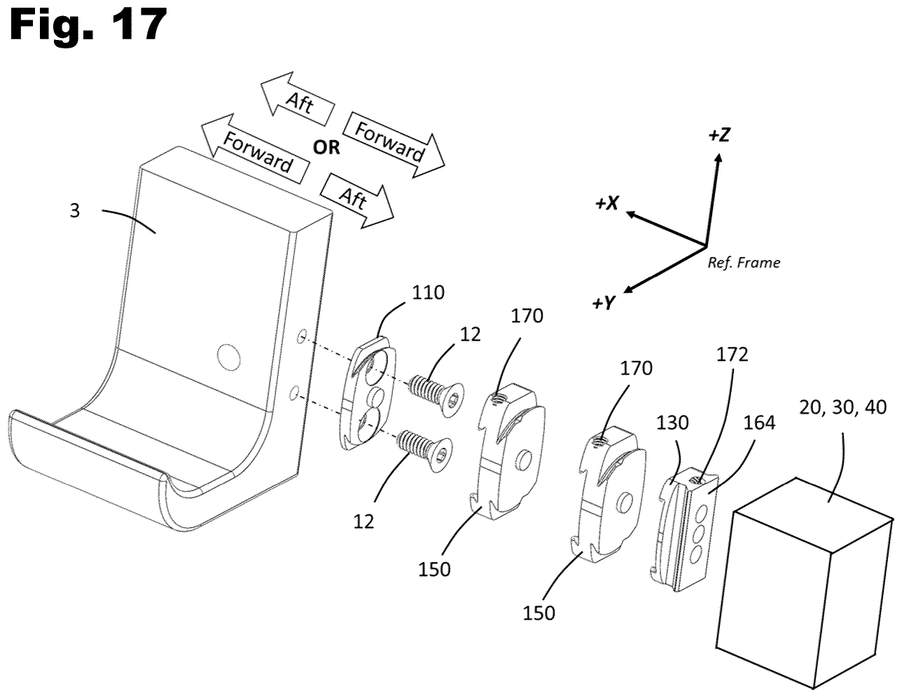

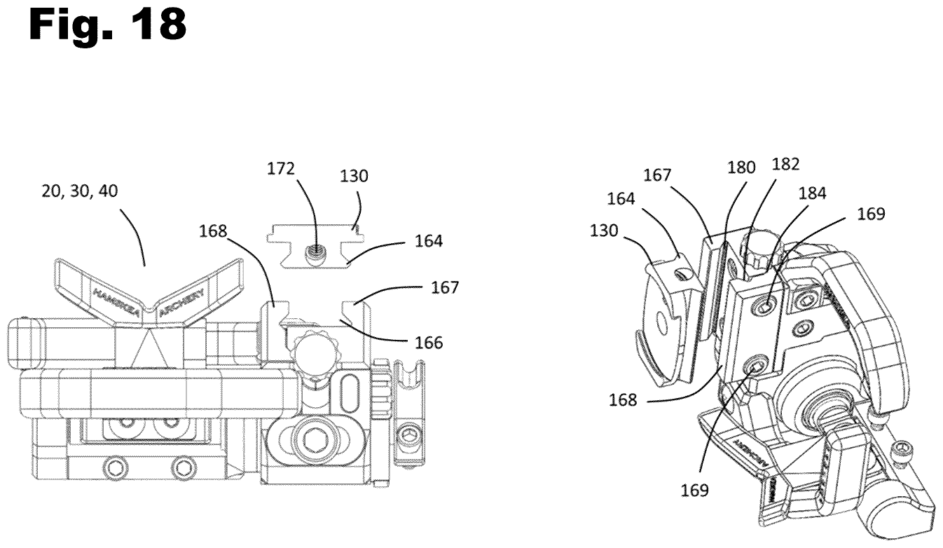

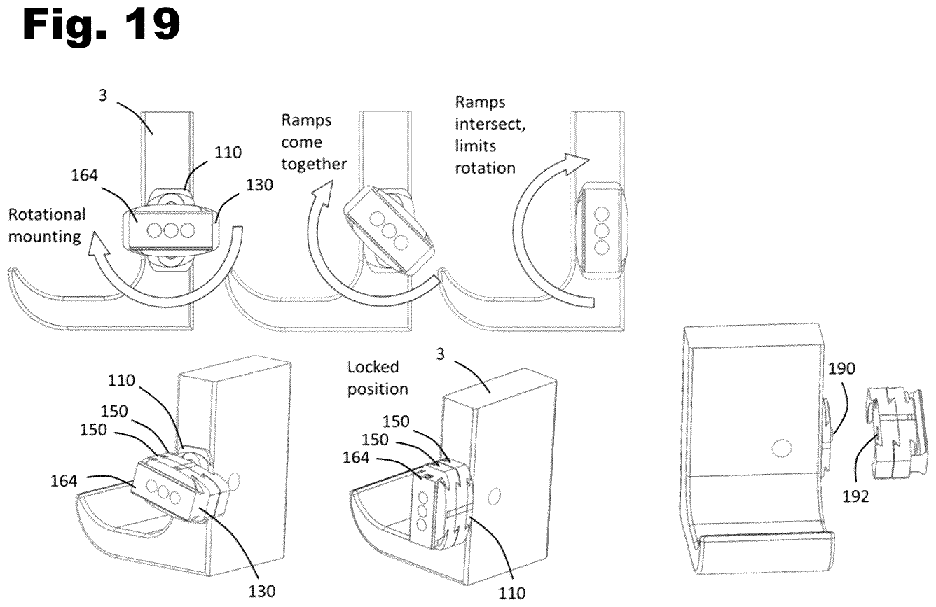

FIG. 16 shows serially configured intermediate components of the example quick mount system 100. FIG. 17 shows an integral accessory mount of the example quick mount system 100. FIG. 18 shows accessory mounting perspectives of the example quick mount system 100. FIG. 19 shows rotational mounting perspectives of the example quick mount system 100.

In an example, the quick mount system 100 includes at least one male component 110 and at least one female component 130. Additional intermediate components 150, 152, 154 and 156 may be placed between the male component 110 and the female component 130. Coupling any two components together requires the male extrusion 112 and the female cavity 132 to be rotationally oriented, such that the ramp feature portion does not interfere. Bringing them together with the centering feature 190 and 192, coaxially aligns the components.

Rotating (clockwise or counter clockwise) one component relative to the other brings the ramp features together where they ultimately make contact with each other and thereby eliminate any further rotation. This defines the locking position and repeatably orients the multiple components 110, 150, 152, 154, 156 and 130 relative to each other. At any interface between the male protrusion 112 and the female cavity 132, the quick mount system 100 can be reconfigured to interchange an accessory (e.g., accessories 20, 30 or 40), or to add or subtract any intermediate components (e.g., components 150, 152, 154 or 156).

The locking or coupling force may be orthogonal (e.g., in one axis only) to the axis of rotation 14, or at a compound angle defined to include a minimum of any two axes of the X, Y or Z coordinate planes and bidirectional (including +X and +Z). The coupling force may apply a rotational force about the axis of rotation by fasteners 170 or 172, or both. The components 150, 152, 154, 156 include a mostly orthogonal surface 180 to the axis of the locking force to allow for the secondary force fastener 170 to intersect. Feature 180 allows the fastener 170 to either push against the mostly orthogonal surface to generate the coupling force, or have a threaded hole (not shown) for the fastener 170 or 172 to couple to and pull any two components 150, 152, 154 or 156 sharing one male protrusion 112 and one female cavity 132 together, thereby generating the coupling force.

The accessories (e.g., accessories 20, 30 or 40) may include a complementary geometric shape 166 to the mounting element 164 (e.g., a Picatinny rail oriented vertically). Accessory engagers 167 and 168 mate to the complementary features of the mounting element 164, allowing the accessory to slide relative to the mounting element 164. Fasteners 169 apply a clamping force, by bringing 167 and 168 together, compressing mounting element 164, and resulting in the mounting element 164 and the accessory (e.g., accessory 20, 30, or 40) being coupled together (e.g., so that it is not moveable). Multiple ramps 180, 182 and 184 provide a repeatable location of the accessory relative to the mounting element 164 when the clamping force is generated by the fasteners 169.

FIG. 20 shows a mounting mechanism female component integral to a structure of the example quick mount system 100. FIG. 21 shows a mounting mechanism male component integral to a structure of the example quick mount system 100. In an example, component 700 or 710 with ramps 702 and 712 (monolithic or one piece) with a secondary locking feature 714 and fastener 716 to any part of structure 3 or intermediate structure 5.

Still other embodiments are contemplated. For example, the quick mount system 100 may include a compressible spring disc which, when overcome by the interference interface between the first interfacing component and the second interfacing component, returns to a non-compressible state to apply a bias force to the interference interface to hold the first interfacing component and the second interfacing component in relative positions to one another. The compressible spring disc may include at least one integral lobe. The integral lobe of the compressible spring disc may be located at a rotational angle of a relative locking position.

In another example, the quick mount system 100 may include a secondary locking mechanism to secure the first interfacing component relative to the second interfacing component in the engagement position. The secondary locking mechanism may be a fastener that threads into and protrudes from the first interfacing component and makes an interference contact with the second interfacing component. The secondary locking mechanism may have a pivoting spring loaded lever arm interfacing with the second interfacing component, and engagement mechanism between the first interfacing component and the second interfacing component to prevent rotation relative to each other.

In yet another example, the quick mount system 100 may include an intermediate component to position the accessory at a prescribed distance from a surface of the mounting structure.

In yet another example, the first interfacing component rotates relative to the second interfacing component into a predisposed angular position where the accessory is monolithic to the mounting structure.

In yet another example, the first interfacing component rotates relative to the second interfacing component to a predisposed angular position where the first interfacing component and the second interfacing component are maintained in the engagement position at least in part by a rotational holding force.

In yet another example, the first interfacing component rotates relative to the second interfacing component to a predisposed angular position where the first interfacing component and the second interfacing component are maintained in the engagement position at least in part by at least one multiple detent that can only be overcome by an external shear force.

In yet another example, releasing the first interfacing component from the second interfacing component is only after releasing a locking ratchet mechanism prior to applying the external shear force.

An intermediate component 150 as a dampener system. In an example, the dampener system is mountable between the male component 110 and the female component 130 of the quick connect/disconnect mounting mechanism 10.

In an example, the dampener system includes a vibration dampening component made of materials that absorb vibration generated by the structure 5 from which it is attached, or vibration generated by an external event or source that is transferred by the structure 5 from which the intermediate component 150 is attached to the male component 110 and the female component 130 of the quick connect/disconnect mounting mechanism 10. The dampener system when attached to the male component 110 and the female component 130 isolates the male component 110 from the female component 130 such that the vibration disturbance is transferred through the dampener.

In an example, the male component 110 is coupled to the dampener with a fastener with a shoulder and threads and a washer. When the fastener is inserted through the dampener the threads of the fastener are mated with the threads of the male component 110, the washer provides increased surface area to transfer the compression force along asserted by threading the fastener into the threaded hole along the axis of rotation 14. The shoulder of fastener limits the dimension along the axis of rotation 14 thereby limiting the deformation of the dampener as the shoulder makes contact with the mating surface of the male component 110.

In an example, the female component 130 is coupled to the dampener with a fastener that threads through the female component 130 and the dampener into the coupling nut that contains threads. When the fastener threads into the threads 264 of the coupling nut, the shoulder of the coupling nut limits the compression force asserted by threading the fastener into the threaded hole. The shoulder of the coupling nut limits the dimension along the axis of rotation 14 thereby limiting the deformation of the dampener as the end of the coupler nut makes contact with the mating surface of the male component 130.

In an example, the male component 110 and female component 130 are not connected directly through the components of the dampener subsystem except for the dampener. The dampener is the transferring component with vibration dampening properties that is compressed between the coupling nut and the washer(s). The coupling nut is coupled to the female component 130 and the washers are coupled to the male component 110 with fasteners. The dimension of the shoulders define the decoupling length of the dampener between the male component 110 and the female component 130.

In an example, the dampener directly contacts the male component 110 and female component 130 through multiple surfaces that represent interfaces (not limited to) in combination with the three axes of the assembly (x, y, z). These interfaces allow for further vibration dampening through the dampener to include forces imparted on the male component 110 (or vise versa) that result is the female component 130 not being coaxially aligned along the axis of rotation 14. This is represented by either the male component 110 or female component 130 having differing X and Y positions relative to the other.

In this example, the female component 130 or weight includes a countersink on mating surface 134 to receive the secondary locking mechanism locking fastener 162 of the male component 110 where the countersink feature allows the locking fastener 162 to mate with the countersink feature beyond the mating surface 134. The axial alignment of the fastener 162 and the countersink feature are slightly misaligned such that the fastener 162 applies a rotational force (X, Y) about the Z axis 14 as the fastener intersects the slope of the countersink feature, resulting in a rotational force that biases the ramp elements 116 of the male component 110 against the ramp element 136 of the female component 130. This prevents the male component 110 and the female component 130 from changing relative positions (X,Y).

In an example, the intermediate component, when coupled to the male component 110 and female component 130, serves as a vibration dampening assembly as part of a series of components as part of the quick connect/disconnect mounting mechanism 10.

It is noted that the examples shown and described are provided for purposes of illustration and are not intended to be limiting. Still other examples are also contemplated.

1. A quick mount system for removably attaching an accessory to a mounting structure, comprising:
a first interfacing component having a receiving element formed therein;
a second interfacing component having a coupler assembly configured to mate with the receiving element in a first position, and rotate into an engagement position relative to the first interfacing component; and
a magnetic coupler to maintain the first interfacing component and the second interfacing component in the engagement position to attach the accessory to the mounting structure.

2. The quick mount system of claim 1, further comprising an interference interface between the first interfacing component and the second interfacing component, the interference interface limiting rotation of the first interfacing component and the second interfacing component relative to each other.

3. The quick mount system of claim 2, wherein the interference interface comprises at least one ramp formed on the receiving element formed in the first interfacing component, and at least one corresponding ramp on the coupler assembly of the second interfacing component.

4. The quick mount system of claim 3, wherein the at least one ramp formed on the receiving element mates with the at least one corresponding ramp on the coupler assembly, and tighten together as the first interfacing component is rotated in a first direction relative to the second interfacing component.

5. The quick mount system of claim 4, wherein the at least one ramp formed on the receiving element mates with the at least one corresponding ramp on the coupler assembly, and loosen from one another as the first interfacing component is rotated in a second direction opposite the first direction relative to the second interfacing component.

6. The quick mount system of claim 3, wherein the at least one ramp formed on the receiving element has a circular shape such that relative rotation between the first interfacing component and the second interfacing component axially align while limiting the rotation to less than one relative revolution.

7. The quick mount system of claim 6, wherein the at least one corresponding ramp formed on the coupler assembly has an elliptical shape such that relative rotation between the first interfacing component and the second interfacing component axially align while limiting the rotation to less than one relative revolution.

8. The quick mount system of claim 7, wherein the circular shape of the receiving element has a diameter that is less than the diameter of the ellipse shape of the coupler assembly.

9. The quick mount system of claim 1, wherein the magnetic coupler generates a magnetic force between at least one magnet on the first interfacing component and at least one corresponding magnet on the second interfacing component.

10. The quick mount system of claim 9, wherein the at least one magnet and the at least one corresponding magnet are substantially axially aligned in the engagement position.

11. The quick mount system of claim 9, wherein magnetic fields of the at least one magnet and the at least one corresponding magnet are substantially parallel to an axis of rotation of the first interfacing component relative to the second interfacing component, wherein the magnetic fields of the at least one magnet and the at least one corresponding magnet are arranged North-to-South and South-to-North for magnetic coupling.

12. A quick mount system for removably attaching an accessory to a mounting structure, comprising:
a first interfacing component having a receiving element formed therein;
a second interfacing component having a coupler assembly configured to mate with the receiving element in a first position, and rotate into an engagement position relative to the first interfacing component;
a magnetic coupler to maintain the first interfacing component and the second interfacing component in the engagement position to attach the accessory to the mounting structure; and
a secondary locking mechanism operable to prevent the first interfacing component from rotating relative to the second interfacing component when in the engagement position.

13. A quick mount system for removably attaching an accessory to a mounting structure, comprising:
a first interfacing component having a receiving ramp element formed therein;
a second interfacing component having a coupler assembly configured to mate with the receiving ramp element in a first position, and rotate into an engagement position relative to the first interfacing component, wherein rotation is limited by the respective ramps interfacing with one another;
a magnetic coupler to maintain the first interfacing component and the second interfacing component in the engagement position to attach the accessory to the mounting structure; and
a secondary locking mechanism operable to prevent the first interfacing component from rotating relative to the second interfacing component when in the engagement position.

14. The quick mount system of claim 13, wherein the secondary locking mechanism comprises a set screw and an interference interface between the first interfacing component and the second interfacing component, the interference interface limiting rotation of the first interfacing component and the second interfacing component relative to each other, wherein the interference interface comprises at least one ramp formed on the receiving element formed in the first interfacing component, and at least one corresponding ramp on the coupler assembly of the second interfacing component.

15. The quick mount system of claim 14, wherein the at least one ramp formed on the receiving element mates with the at least one corresponding ramp on the coupler assembly, tightening together as the first interfacing component is rotated in a first direction relative to the second interfacing component, and loosening from one another as the first interfacing component is rotated in a second direction opposite the first direction relative to the second interfacing component.

16. (canceled)

17. The quick mount system of claim 13, wherein the at least one ramp formed on the receiving element has a circular shape such that relative rotation between the first interfacing component and the second interfacing component axially align while limiting the rotation to less than one relative revolution, the at least one corresponding ramp formed on the coupler assembly has an elliptical shape such that relative rotation between the first interfacing component and the second interfacing component to axially align while limiting the rotation to less than one relative revolution.

18. The quick mount system of claim 13, wherein the magnetic coupler generates a magnetic force between at least one magnet on the first interfacing component and at least one corresponding magnet on the second interfacing component.

19. The quick mount system of claim 18, wherein the at least one magnet and the at least one corresponding magnet are substantially axially aligned in the engagement position.

20. The quick mount system of claim 19, wherein magnetic fields of the at least one magnet and the at least one corresponding magnet are substantially parallel to an axis of rotation of the first interfacing component relative to the second interfacing component, wherein the magnetic fields of the at least one magnet and the at least one corresponding magnet are arranged North-to-South and South-to-North for magnetic coupling.
